(19) United States
(12) Patent Application Publication
(10) Pub. No.: US 2015/0191676 A1
(43) Pub. Date: Jul. 9, 2015

(54) LIQUID LAUNDRY DETERGENTS WITH IMPROVED SUDS PROFILE

(71) Applicant: The Procter & Gamble Company, Cincinnati, OH (US)

(72) Inventors: Wenting LIU, Beijing (CN); Ming TANG, Beijing (CN)

(21) Appl. No.: 14/592,252

(22) Filed: Jan. 8, 2015

(30) Foreign Application Priority Data
Jan. 8, 2014 (WO) CN2014/070271

(51) Int. Cl. C11D 1/29; C11D 17/00; C11D 11/00

(52) U.S. Cl. CPC C11D 1/29; C11D 11/0017; C11D 17/0008

(57) ABSTRACT

The present invention relates to a liquid laundry detergent composition containing an alkylethoxy sulfate (AES) surfactant in combination with two or more fatty acids characterized by a specific Fatty Acids Distribution Profile for achieving improved suds profile.

### FIELD OF THE INVENTION

The present invention relates to liquid laundry detergents containing an anionic surfactant that is an alkylethoxy sulfate or salt thereof in combination with two or more fatty acids or salts thereof having a specific Fatty Acids Distribution Profile. Such liquid laundry detergents exhibit improved suds profile, i.e., relatively high wash suds volume and relatively low rinse suds volume, which is particularly desirable for hand washing of fabrics because it allows consumers to experience ample suds during the wash cycle while enabling easy rinse in subsequent rinse cycles.

### BACKGROUND OF THE INVENTION

Laundry detergents comprising anionic detersive surfactants for cleaning fabrics have been known for many years. Historically, cleaning laundry was defined primarily as a process that involved removal of stains. Consistent with this historical approach to cleaning, laundry detergent designers focused on formulating detergents with long chain surfactants to ensure maximum surface activity of the surfactants to achieve the most removal of soil. Correspondingly, consumers viewed copious suds in the wash as the primary and most desirable signal of cleaning. High suds are especially desirable during hand washing of fabrics, since the consumer can directly feel and touch the suds generated during the wash cycle and will intuitively correlates the high suds volume with the achievement of sufficient fabric cleaning.

As fabrics, consumer habits and chemistries evolve, consumers are recognizing that cleaning of soils off fabrics is no longer the only or even biggest challenge they meet. As consumers become more sophisticated, they are recognizing that surfactants that generate copious suds in the wash also do not rinse well and tend to leave chemical residues on fabrics. Therefore, if suds are still present during the rinse, then the consumers immediately infer from it that there may still be surfactant residue on the fabrics and that the fabrics are not yet “clean”. As a result, the consumers feel the need to rinse the fabrics multiple times in order to make sure that the surfactants are removed as thoroughly as other soils.

Hence, while a large volume of suds is desirable during the wash cycle of fabric cleaning, it is paradoxically undesirable during the rinse cycle. As water is often a limited resource, especially in hand washing countries, the use of water for rinsing reduces the amount of water available for other possible uses, such as irrigation, drinking, bathing, etc.

There is therefore a need for a smart surfactant system that is tuned to provide enough surfactant activity to ensure effective fabric cleaning as well as a desirable level of suds in the wash, but to subsequently suppress sudsing during the rinse, so that consumers perceive the surfactants as capable of being easily rinsed away in a single rinse cycle.

### SUMMARY OF THE INVENTION

The present invention correspondingly provides a smart surfactant system that strikes a right balance between those surfactants with very high surface activity (e.g., those with long chains) that enable effective cleaning and also build suds volume during the wash cycle with those surfactants that are more water soluble (e.g., short chain fatty acids) to reduce formation of suds during the more water-rich rinse cycle of the laundering process.

In one aspect, the present invention relates to a liquid laundry composition that contains:
(a) from 1 wt % to 20 wt % of a C₁₀-C₂₀ linear or branched alkylethoxy sulfate (AES) having an average degree of ethoxylation ranging from 1 to 3; and
(b) from 0.1 wt % to 4 wt % of two or more fatty acids or salts thereof, while the two or more fatty acids or salts have a Fatty Acids Distribution Profile characterized by from 30% to 90% of C₁₄ saturated fatty acids or salts by total weight of such two or more fatty acids or salts.

The above-specified Fatty Acids Distribution Profile is particularly designed for maximizing suds reduction during the rinse cycle without compromising suds generation during the wash cycle. This Fatty Acids Distribution Profile is not available in natural fatty acid mixtures often employed in traditional laundry detergents, because such natural fatty acid mixtures typically contain a significantly lower C₁₄ content. Liquid laundry detergent compositions of the present invention with the above-specified Fatty Acids Distribution Profile exhibit an improved suds profile, i.e., generating a higher suds volume during the wash cycle and a lower suds volume during the rinse cycle, in comparison with similar laundry detergent compositions either free of any fatty acids or containing fatty acids that do not fit into the above-specified Fatty Acids Distribution Profile.

Preferably, the Fatty Acids Distribution Profile of the present invention is further characterized by:

(i) from 5% to 50% of C₁₂ saturated fatty acids or salts thereof;
(ii) from 35% to 80% of C₁₄ saturated fatty acids or salts thereof;
(iii) from 0% to 35% of C₁₆ saturated fatty acids or salts thereof; and
(iv) from 0% to 10% of C₁₈ saturated fatty acids or salts thereof,
by total weight of such two or more fatty acids or salts.

More preferably, the Fatty Acids Distribution Profile of the present invention is further characterized by at least 80 wt %, preferably at least 90 wt %, and more preferably 100 wt %, of saturated fatty acids or salts thereof.

The liquid laundry detergent composition of the present invention may also be characterized by an AES-to-fatty-acids weight ratio ranging from 40:1 to 1:2, respectively, preferably from 20:1 to 1:1, and more preferably from 15:1 to 2:1.

It is further preferred, although not necessary, that the liquid laundry detergent composition of the present invention has a pH value ranging from 6 to 9, and preferably from 7 to 8.

As a result of incorporating the two or more fatty acids or salts having the above-described Fatty Acids Distribution Profile, the liquid laundry detergent compositions of the present invention exhibit an improved suds profile, in comparison with laundry detergent compositions that are either free of any fatty acids or contain fatty acids that do not fit into the above-specified Fatty Acids Distribution Profile, as demonstrated by experiments hereinafter. Specifically, it is preferred that the liquid laundry detergent compositions of the present invention have a suds profile that is characterized by: (1) a Wash Suds Height of greater than 20 cm, preferably greater than 25 cm, and more preferably greater than 28 cm; and (2) a Rinse Suds Height of less than 10 cm, preferably less than 8 cm, and more preferably less than 7 cm, while the Wash Suds Height and Rinse Suds Height are measured by the tests described hereinafter.

The present invention in another aspect provides a concentrated liquid laundry detergent composition containing:
(a) from 20 wt % to 50 wt % of a C₁₀-C₂₀ linear or branched alkylethoxy sulfate (AES) having an average degree of ethoxylation ranging from 1 to 3; and
(b) from 4 wt % to 10 wt % of two or more fatty acids or salts thereof, wherein the two or more fatty acids or salts have a Fatty Acids Distribution Profile that is characterized by from 30% to 90% of C₁₄ saturated fatty acids or salts thereof by total weight of the two or more fatty acids or salts.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, the terms “consisting essentially of” means that the composition contains less than 5%, preferably less than 1%, of ingredients other than those listed. Further, the terms “essentially free of,” “substantially free of” or “substantially free from” means that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are by average number molecular weight unless otherwise specifically noted.

As used herein, the term “liquid” includes liquid, paste, wax, gel, and mixtures thereof, including liquid compositions packaged in water-soluble capsules or pouches. The liquid composition may comprise one or more solids suspended therein, including powders or agglomerates, e.g., micro-capsules, beads, noodles, or pearlized balls. Such solids may provide a technical benefit or an aesthetic effect.

As used herein, “compact” or “concentrated” refers to a liquid composition that comprises less than about 35% water by total weight of the liquid composition.

As used herein, the term “Fatty Acids Distribution Profile” refers to the compositional breakdown of the fatty acid/salts mixtures used for practice of the present invention, based on the carbon chain length, linear or branched structures, degrees and/or types of saturation, degrees and/or types of substitutions, etc. of the fatty acids/salts.

As used herein, “suds” indicates a non-equilibrium dispersion of gas bubbles in a relatively smaller volume of a liquid. The terms like “suds”, “foam” and “lather” can be used interchangeably within the meaning of the present invention.

As used herein, “suds profile” refers to the properties of a detergent composition relating to suds character during the wash and rinse cycles. The suds profile of a detergent composition includes, but is not limited to, the speed of suds generation upon dissolution in the laundering liquor, the volume and retention of suds in the wash cycle, and the volume and disappearance of suds in the rinse cycle. Preferably, the suds profile includes the Wash Suds Height and Rinse Suds Height as specifically defined by the testing methods disclosed hereinafter in the examples. It may further include additional suds-related parameters, such as suds stability measured during the washing cycle and the like.

### Detergent Composition

As used herein the phrase “detergent composition” includes compositions and formulations designed for cleaning or treating fabrics or similar flexible materials consisting of a network of natural or artificial fibers, including natural, artificial, and synthetic fibers, e.g., cotton, linen, wool, polyester, nylon, silk, acrylic, or blends thereof. Such detergent compositions include but are not limited to, laundry cleaning compositions, fabric softening compositions, fabric enhancing compositions, fabric freshening compositions, laundry prewash, laundry pre-treat, laundry additives, spray products, dry cleaning agents or compositions, laundry rinse additives, wash additives, post-rinse fabric treatment compositions, ironing aids, unit dose formulations, delayed delivery formulations, liquid hand dishwashing compositions, detergents contained on or in a porous substrate or nonwoven sheet, and other suitable forms that may be apparent to one skilled in the art in view of the teachings herein. Such detergent compositions may be used as a pre-laundering treatment, a post-laundering treatment, or may be added during the rinse or wash cycle of the laundering operation.

The detergent compositions of the present invention are preferably in a liquid form, either as single-phase or multi-phase products. The liquid detergent composition of the present invention is preferably characterized by a pH value ranging from 6 to 9, and preferably from 7 to 8. Such liquid compositions can be packaged in any suitable container, such as bottles, flexible pouches, and the like, and they can also be packaged as unit dose products in water-soluble films. Preferably, but not necessarily, the detergent compositions are provided in a concentrated form with a significantly lower water content and higher concentrations of laundering actives.

The detergent compositions disclosed herein employ one or more anionic surfactants, preferably an alkylethoxy sulfate (AES), in combination with a mixture of two or more fatty acids or salts characterized by a specific Fatty Acids Distribution Profile to achieve improved suds profile, as disclosed hereinafter.

### Fatty Acids

The mixture of two or more fatty acids or salts thereof (hereinafter “fatty acids/salts”) as used in the present invention distinguishes from the naturally occurring fatty acids in its Fatty Acid Distribution Profile. Most naturally occurring mixture of fatty acids/salts contain less than 20% of C₁₄ saturated fatty acids/salts by total weight. In contrast, the mixture of fatty acids/salts used for practice of the present invention contains from 30% to 90% of C₁₄ fatty acids/salts. Preferably, the mixture of fatty acids/salts used in the present invention contains: (i) from 5% to 50%, preferably from 10% to 45%, and more preferably from 20% to 40%, of C₁₂ saturated fatty acids/salts; (ii) from 35% to 80%, preferably from 50% to 80%, and more preferably from 60% to 80%, of C₁₄ saturated fatty acids/salts; (iii) from 0% to 35%, preferably from 10% to 30%, and more preferably from 15% to 30%, of C₁₆ saturated fatty acids/salts; and (iv) from 0% to 10%, preferably from 0% to 5%, and more preferably from 1% to 2%, of C₁₈ saturated fatty acids/salts, by total weight of such mixture.

Following is a table showing the Fatty Acids Distribution Profile of the fatty acid mixture of the present invention in comparison with the Fatty Acids Distribution Profiles of several naturally occurring mixtures of fatty acids:

TABLE I

| | Fatty Acids Distribution Profile (wt %) | | | | | | | | | |
|---|---|---|---|---|---|---|---|---|---|---|
| Fatty Acid Mixture | C₆₋₈ | C₁₀ | C₁₂ | C₁₄ | C₁₆ | C₁₈ | C_{18:1}* | C_{18:2}** | C_{18:3}*** | C₂₀ |
| Inventive Mixture | 0 | 0 | 5-50 | 35-80 | 0-35 | 0-10 | 0 | 0 | 0 | 0 |
| Palm kernel oil | 0 | 3-7 | 46.9-52 | 14.1-17.5 | 6.5-8.8 | 1.3-2.5 | 10.5-18.5 | 0.7 | 1.3 | 0 |
| Coconut oil | 5.5-9.5 | 4.5-9.5 | 44-52 | 13-19 | 7.5-10.5 | 1-3 | 0 | 0 | 0 | 0-0.4 |
| Beef Tallow | 0 | 0 | 0 | 2-7.8 | 24-32.5 | 14.1-28.6 | 38.9-49.5 | 0-5 | 0 | 0 |
| Mutton Tallow | 0 | 0 | 0 | 4.6 | 24.6 | 30.5 | 36 | 4.3 | 0 | 0 |

*C_{18:1} stands for an unsaturated C₁₈ fatty acid with one double bond.
**C_{18:2} stands for an unsaturated C₁₈ fatty acid with two double bonds.
***C_{18:3} stands for an unsaturated C₁₈ fatty acid with three double bonds.
All other fatty acids listed hereinabove are saturated fatty acids.

Inventors of the present invention discovered surprisingly and unexpectedly that the Fatty Acids Distribution Profile of the fatty acid mixture used in forming the liquid laundry detergent compositions of the present invention has a significant impact on the resulting suds profile. Specifically, when the C₁₄ saturated fatty acid content in the fatty acid mixture is within the desired range of 30-90%, the resulting suds profile is significantly better than those fatty acid mixtures with either less or more C₁₄ fatty acids.

Suitable fatty acids that can be used to make the fatty acid mixture of the present invention include C₁₀-C₂₂ fatty acids or alkali salts thereof. Such alkali salts include monovalent or divalent alkali metal salts like sodium, potassium, lithium and/or magnesium salts as well as the ammonium and/or alkylammonium salts of fatty acids, preferably the sodium salt. Preferred fatty acids for use herein contain from 12 to 20 carbon atoms, and more preferably 12 to 18 carbon atoms.

Exemplary fatty acids that can be used may be selected from caprylic acid, capric acid, lauric acid, myristic acid, myristoleic acid, palmitic acid, palmitoleic acid, sapienic acid, stearic acid, oleic acid, elaidic acid, vaccenic acid, linoleic acid, linoelaidic acid, α-linoelaidic acid, arachidic acid, arachidonic acid, eicosapentaenoic acid, behenic acid, erucic acid, and docosahexaenoic acid, and mixtures thereof.

Further, it is preferred that the Fatty Acids Distribution Profile of the fatty acid mixture of the present invention is characterized by at least 80 wt %, preferably at least 90 wt %, and more preferably 100 wt %, of saturated fatty acids, such as caprylic acid, capric acid, lauric acid, myristic acid, palmitic acid, stearic acid, arachidic acid, behenic acid, and mixtures thereof.

Among the above-listed saturated fatty acids, lauric acid, myristic acid and palmitic acid are particularly preferred. In most preferred embodiments of the present invention, the fatty acid mixture of the present invention are essentially made of lauric acid, myristic acid and palmitic acid. For example, the fatty acid mixture of the present invention may contain from 10 wt % to 40 wt % lauric acid, from 35 wt % to 80 wt % myristic acid, and from 10 wt % to 30 wt % palmitic acid. More preferably, the fatty acid mixture of the present invention consists essentially of from 10 wt % to 30 wt % lauric acid, from 35 wt % to 80 wt % myristic acid, and from 10 wt % to 30 wt % palmitic acid, and is substantially free of any other fatty acids.

The fatty acid mixture is preferably present in the liquid laundry detergent compositions of the present in an amount ranging from 0.1 wt % to 4 wt %, more preferably from 0.5 wt % to 3 wt %, and most preferably from 1 wt % to 2 wt %. If the liquid laundry detergent compositions are provided in a concentrated form, then the fatty acid mixture is preferably present in an amount ranging from 4 wt % to 10 wt %, more preferably from 5 wt % to 8 wt %, and most preferably from 6 wt % to 7 wt %, while the Fatty Acids Distribution Profile of such mixture remains the same as discussed hereinabove.

### Anionic Surfactants

The anionic surfactant used in the liquid laundry detergent compositions of the present invention is preferably a C₁₀-C₂₀ linear or branched alkylethoxy sulfate (AES). Specifically, the anionic surfactant is an AES with the following formula (I):

R—O—(C₂H₄O)ₓ—SO₃⁻M⁺ (I),

wherein R is a linear or branched alkyl chain having from 10 to 20 carbon atoms, either saturated or unsaturated; x averages from 1 to 3; and M is selected from the group consisting of alkali metal ions, ammonium, or substituted ammonium. Preferably, R is a linear or branched alkyl chain having from 12 to 16 carbon atoms; x averages 3; and M is sodium. The most preferred anionic surfactant for the practice of the present invention is sodium lauryl ether sulphate with an average degree of ethoxylation of about 3.

The AES is preferably present in the liquid laundry detergent compositions of the present in an amount ranging from 1 wt % to 20 wt %, more preferably from 2 wt % to 15 wt %, and most preferably from 5 wt % to 10 wt %.

If the liquid laundry detergent compositions are provided in a concentrated form, then the AES is preferably present in an amount ranging from 20 wt % to 50 wt %, more preferably from 25 wt % to 45 wt %, and most preferably from 30 wt % to 40 wt %.

Preferably, but not necessarily, the AES-to-fatty-acids weight ratio in the liquid laundry detergent compositions of the present invention ranges from 40:1 to 1:2, preferably from 20:1 to 1:1, and more preferably from 15:1 to 2:1, respectively.

Other anionic surfactants, such as alkyl sulphates and alkyl aryl sulphonates, can also be included in the detergent compositions of the present invention. Preferred alkyl sulphates (AS) include C₆₋₁₈ alkyl sulphates, and more preferably C₁₂ alkyl sulphates. Suitable alkyl benzene sulphonates (LAS) are preferably C₁₀₋₁₃ alkyl benzene sulphonates. LAS are preferably obtained by sulphonating commercially available linear alkyl benzenes (LAB). Suitable LAB includes low 2-phenyl LAB, such as those supplied by Sasol under the tradename Isochem® or those supplied by Petresa under the tradename Petrelab®. Other suitable LAB includes high 2-phenyl LAB, such as those supplied by Sasol under the tradename Hyblene®. Other suitable LAS can be obtained by the DETAL catalyzed process or the HF synthesis route. Alkyl ethoxylated carboxylic acids can also be used as anionic surfactants herein. The alkyl sulphates, alkyl benzene sulphonates and alkyl ethoxylated carboxylic acids as described herein may be linear or branched, substituted or un-substituted.

Additional anionic surfactants that can be used for practice of the present invention include long chain (fatty) alcohol sulphates, olefin sulphates and sulphonates, sulphonated polycarboxylic acids, sulphated monoglycerides, sulphate esters, phosphate esters, sulphonated or sulphated ethoxylate alcohols, sulphosuccinates, isethionates, taurates, sarcosinates, succinamates, and the like. Particularly suitable for use is a long chain C₁₁-C₁₅ acyl sarcosinate in its acid and/or salt form, which is rapidly and completely biodegradable and have good skin compatiability.

In a specific embodiment, the liquid laundry detergent compositions of the present invention contain only one type of anionic surfactant which is AES. In alternative embodiments of the present invention, the liquid laundry detergent compositions comprise a mixture of anionic surfactants. For example, the liquid laundry detergent compositions contain a mixture of AES and LAS at an AES-to-LAS ratio ranging from 90:10 to 10:90, preferably from 75:25 to 25:75, and more preferably from 65:35 to 35:65. For another example, the liquid laundry detergent compositions contain a mixture of AES with AS at an AES-to-AS ratio 90:10 to 10:90, preferably from 75:25 to 25:75, and more preferably from 65:35 to 35:65. The AS useful for practice of the present invention is preferably a C₆-C₁₄ alkyl sulphate having the formula R₁—O—SO₃⁻M⁺, wherein R₁ is a linear or branched alkyl chain having from 6 to 14 carbon atoms. More preferably, the AS is a predominately C₁₂ alkyl sulphate having the formula R₁₂—O—SO₃⁻M⁺, wherein R₁₂ is a linear or branched alkyl chain having 12 carbon atoms. Other similar suds-boosting anionic surfactants can also be used as co-surfactants with AES and included in the laundry detergent compositions of the present invention.

### Other Surfactants

Other surfactants useful herein include nonionic surfactants, zwitterionic surfactants, cationic surfactants, and mixtures thereof.

The liquid laundry detergent compositions of the present invention may contain one or more nonionic surfactants as a co-surfactant in the amount of up to about 25%, by total weight of all the surfactants. In some examples, the liquid laundry detergent compositions comprise from about 0% to 25%, preferably 0.1% to about 15%, more preferably from 1% to about 10%, and most preferably from about 5% to about 8% by total weight of all the surfactants, of one or more nonionic surfactants. If the liquid laundry detergent compositions are provided in a concentrated form, then the nonionic surfactants is preferably present in an amount ranging from 0 wt % to 50 wt %, more preferably from 25 wt % to 45 wt %, and most preferably from 30 wt % to 40 wt %.

Suitable nonionic surfactants useful herein can comprise any conventional nonionic surfactant. These can include, for e.g., alkoxylated fatty alcohols and amine oxide surfactants. In some examples, the cleaning compositions may contain an ethoxylated nonionic surfactant. These materials are described in U.S. Pat. No. 4,285,841, Banat et al, issued Aug. 25, 1981. The nonionic surfactant may be selected from the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. In one example, the nonionic surfactant is selected from ethoxylated alcohols having an average of about 24 carbon atoms in the alcohol and an average degree of ethoxylation of about 9 moles of ethylene oxide per mole of alcohol.

Other non-limiting examples of nonionic surfactants useful herein include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1 to 30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 to Llenado, issued Jan. 26, 1986; specifically alkylpolyglycosides as discussed in U.S. Pat. No. 4,483,780 and U.S. Pat. No. 4,483,779; Polyhydroxy fatty acid amides as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

The liquid laundry detergent compositions of the present invention may also comprise a cationic surfactant, although in most situations the liquid laundry detergent compositions of the invention are substantially free of cationic surfactants and surfactants that become cationic below a pH of 7 or below a pH of 6. Non-limiting examples of cationic surfactants include: quaternary ammonium surfactants; dimethyl hydroxyethyl quaternary ammonium; dimethyl hydroxyethyl lauryl ammonium chloride; trimethyl lauryl ammonium chloride; polyamine cationic surfactants; cationic ester surfactants; and amino surfactants, specifically amido propyldimethyl amine (APA), and the like.

The liquid laundry detergent compositions of the present invention may further comprise a zwitterionic or amphoteric surfactant, such as imidazoline compounds, alkylaminoacid salts, betaine or betaine derivatives, C₈ to C₁₈ amine oxides and specifically C₁₂ to C₁₄ alkyldimethyl amine oxide, and the like.

When the liquid laundry detergent compositions of the present invention contain other anionic surfactants (in addition to AES) and/or nonionic surfactants, it is preferred that the total surfactant-to-fatty-acids weight ratio in such liquid laundry detergent compositions is within the range of from 40:1 to 1:2, respectively, preferably from 20:1 to 1:1, and more preferably from 15:1 to 2:1. Further, it is preferred to maintain the total surfactant content in the liquid laundry detergent compositions of the present invention at no more than 25 wt %, preferably no more than 15 wt %, and more preferably no more than 10 wt %.

### Builder

Examples of suitable builders which may be used include water-soluble alkali metal phosphates, polyphosphates, borates, citrates, silicates and also carbonates; water-soluble amino polycarboxylates; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, boric acid, citric acid, and carboxymethyloxysuccinic acid, salts of polymers of itaconic acid and maleic acid, tartrate monosuccinate, tartrate disuccinate. In a preferred embodiment of the present invention, the liquid laundry detergent composition comprises from 0 wt % to 9 wt % of citric acid or boric acid.

### Organic Solvent

The liquid laundry detergent compositions of the present invention preferably comprise one or more organic solvents, which may be present in an amount ranging from 0.05% to 25%, or from 0.1% to 15%, or from 1% to 10%, or from 2% to 5%, by total weight of the compositions. The compositions may comprise less than 5%, or less than 1%, organic solvent. In certain aspects, the compositions are substantially free of organic solvents.

The organic solvent, if present, may be selected from 1,2-propanediol, methanol, ethanol, glycerin, dipropylene glycol, diethylene glycol (DEG), methyl propanediol, pentanediol, sodium cumene sulfonate, potassium cumene sulfonate, ammonium cumene sulfonate, sodium toluene sulfonate, potassium toluene sulfonate, sodium xylene sulfonate, potassium xylene sulfonate, ammonium xylene sulfonate, or mixtures thereof. Other lower alcohols, such C₁-C₄ alkanolamines, e.g., monoethanolamine and/or triethanolamine, may also be used. In a particularly preferred embodiment of the present invention, the liquid laundry detergent compositions of the present invention contain from 1 wt % to 25 wt % of one or more organic solvents selected from the group consisting of glycerin, pentanediol, 1,2-propanediol, ethanol, diethylene glycol, sodium cumene sulfonate, and monoethanolamine.

### Additional Detergent Ingredients

The balance of the laundry detergent typically contains from about 5% to about 70%, or about 10% to about 60% adjunct ingredients. Suitable detergent ingredients include: transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6 R and 2.0 R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### EXAMPLES

### Test Sample Preparation

Three (3) exemplary liquid laundry compositions containing fatty acid mixtures having the Fatty Acids Distribution Profiles as specified hereinabove for the present invention, together with four (4) comparative liquid laundry compositions containing fatty acid mixtures with Fatty Acids Distribution Profiles not within the scope of the present invention, are provided as follows:

TABLE II

| | | | | Comparative | Comparative | Comparative | Comparative |
|---|---|---|---|---|---|---|---|
| Ingredients | | | | Example 1 | Example 2 | Example 3 | Example 4 |
| (wt %) | Example 1 | Example 2 | Example 3 | (Palm kernel oil) | (tallow oil) | (lower C14) | (higher C14) |
| AE3S | 5% | 5% | 5% | 5% | 5% | 5% | 5% |
| HLAS | 10% | 10% | 10% | 10% | 10% | 10% | 10% |
| Total fatty acids | 1.2% | 1.2% | 1.2% | 1.2% | 1.2% | 1.2% | 1.2% |
| C12 | 40% | 20% | 20% | 50 +/− 10% | 0% | 80% | 0% |
| C14 | 50% | 70% | 80% | 17 +/− 3% | 3% | 20% | 100% |
| C16 | 10% | 10% | 0% | 9 +/− 3% | 29% | 0% | 0% |
| C18 | 0% | 0% | 0% | 2.5 +/− 2.5% | 23% | 0% | 0% |
| C18:1 | 0% | 0% | 0% | 17 +/− 5% | 45% | 0% | 0% |
| Citric Acid | 2% | 2% | 2% | 2% | 2% | 2% | 2% |
| 1,2-pdiol | 2% | 2% | 2% | 2% | 2% | 2% | 2% |
| NaOH | Balance pH to 7.6 +/− 0.3 | | | | | | |
| DI Water | Q.S. | Q.S. | Q.S. | Q.S. | Q.S. | Q.S. | Q.S |

Each of the above-described liquid laundry compositions is formed by first mixing all ingredients into a 150 ml plastic bottle. One magnet bar is inserted into the plastic bottle, which is then capped with a screw lid. The plastic bottle containing the ingredients is then placed on top of an IKA magnetic stirrer (Model RT 15 power IKAMAG), which is set to rotate at the speed of 300 rpm and at the temperature of 80° C. The magnetic stirrer is operated for about 8 hours until all ingredients are dissolved.

### Tests for Measuring Wash Suds Height and Rinse Suds Height

Smart surfactant systems generate an optimal suds profile that is a combination of just enough suds in the wash, while minimizing suds in the rinse. To demonstrate this profile, two methods are used to measure: (1) Wash Suds Height using a Suds Cylinder Tester (SCT); and (2) Rinse Suds Height also by using the SCT. To achieve standard testing conditions, reversed-osmosis water (“RO-water”) is used, and standardized water hardness is achieved by adding sodium bicarbonate to the appropriate level to achieve suitably representative water hardness. For the purposes of this testing, the target water hardness is 16 gpg.

Wash Suds Height is measured to compare suds volume generated during the washing stage by laundry detergent compositions of the present invention comprising the fatty acid mixture having the specified Fatty Acids Distribution Profile with suds volume generated by one or more comparative laundry detergent compositions that do not have the specified Fatty Acids Distribution Profile. The higher the Wash Suds Height, the better the results.

Rinse Suds Height is used to compare the suds volume remaining after rinsing of laundry detergent compositions of the present invention comprising the fatty acid mixture having the specified Fatty Acids Distribution Profile with suds volume generated by one or more comparative laundry detergent compositions that do not have the specified Fatty Acids Distribution Profile. The lower the Rinse Suds Height, the better the results.

The suds volume of the respective laundry detergent compositions can be measured by employing a suds cylinder tester (SCT). The SCT has a set of 8 cylinders. Each cylinder is a columniform plastic cylinder of about 66 cm in height and 50 mm in diameter, with rubber stopple for airproofing independently rotated at a rate of 21-25 revolutions per minute (rpm). The external wall of each cylinder contains markings for heights, with 0 mm starting from the top surface of the cylinder bottom and ending with 620 mm as the maximum measurable height.

For each suds volume measurement, a test solution is first poured into one of the cylinders in the SCT, which is then rotated for a number of revolutions as specified below, and then stopped. The suds height of the test solution inside the cylinder is read at about 1 minute after the rotation of the SCT is stopped. The suds height is calculated as the height of the top layer of suds minus the height of the test solution in the cylinder. The height of the top layer of suds is determined by the imaginary line that is at the highest point in the column of suds that passes through suds only without intersecting air and it is vertical to the cylinder wall. Scattered bubbles clinging to the interior surface of the cylinder wall are not counted in reading the suds height.

The Wash Suds Height is an average of four measurements taken after four sets of SCT revolutions. The Wash Suds Height is obtained by dissolving 1.5 g of a sample liquid laundry detergent composition into 300 ml of RO-water adjusted to 16 gpg hardness (60 ppm sodium bicarbonate). The concentration of the laundry detergent solution being measured is 5000 ppm. The 300 ml 5000 ppm laundry detergent solution is then poured into one of the SCT cylinders and the first set of revolutions is started. The first set of SCT revolutions is 10 revolutions. After 10 revolutions the SCT is stopped to allow reading of the suds height. Subsequently, the SCT is rotated for another set of 20 revolutions (30 revolutions in total) and stopped to allow reading of the suds height. The SCT is then rotated for another set of 20 revolutions (50 revolutions in total) and stopped to allow reading of the suds height. The SCT is finally rotated for another set of 20 revolutions (70 revolutions in total) and then stopped to allow reading of the suds height. The average of all four readings at 10, 30, 50, and 70 revolutions, respectively, is calculated and recorded as the Wash Suds Height.

For measuring Rinse Suds Height, 37.5 ml of the previously mentioned 5000 ppm laundry detergent solution used for the Wash Suds Height measurement is poured from the SCT cylinder into a clean beaker, and is further diluted with another 262.5 ml RO-water adjusted to 16 gpg (60 ppm sodium bicarbonate) to simulate a first rinse condition. This 300 ml mixed solution in the beaker is taken as Rinse 1 solution. The SCT cylinder is subsequently cleaned with RO-water, and the 300 ml Rinse 1 solution is poured from the beaker back into the cleaned SCT cylinder. The SCT cylinder containing the 300 ml Rinse 1 solution is then placed back on the SCT, which is rotated for 40 revolutions and stopped to allow reading of the suds height.

Subsequently, one hundred fifty milliliter (150 ml) of the Rinse 1 solution is poured from the SCT cylinder into a clean beaker, and further diluted with another 150 ml RO-water adjusted to 16 gpg (60 ppm sodium bicarbonate) to simulate a second rinse condition. This 300 ml mixed solution in the beaker is taken as Rinse 2 solution. The SCT cylinder is subsequently cleaned with RO-water, and the 300 ml Rinse 2 solution is poured back from the beaker into the cleaned SCT cylinder. The SCT cylinder containing the 300 ml Rinse 2 solution is then placed back on the SCT, which is rotated for 40 revolutions and stopped to allow reading the suds height.

Subsequently, one hundred fifty milliliter of (150 ml) of the Rinse 2 solution is poured from the SCT cylinder into a clean beaker, and further diluted with another 150 ml RO-water adjusted to 16 gpg (60 ppm sodium bicarbonate) to simulate a third rinse condition. This 300 ml mixed solution in the beaker is taken as Rinse 3 solution. The SCT cylinder is subsequently cleaned with RO-water, and the 300 ml Rinse 3 solution is poured back from the beaker into the cleaned SCT cylinder. The SCT cylinder containing the 300 ml Rinse 3 solution is then placed back on the SCT, which is rotated for 40 revolutions and stopped to allow reading the suds height.

The average suds height measured from Rinse 1 solution, Rinse 2 solution, and Rinse 3 solution is calculated and recorded as the Rinse Suds Height.

The same process as described hereinabove is repeated for each of the seven (7) test samples listed in Table II to obtain the Wash Suds Height and the Rinse Suds Height, which can be carried out either sequentially or simultaneously.

The Wash Suds Height and Rinse Suds Height measured for each of the above-mentioned seven (7) test samples are measured using the testing methods described hereinabove, and the results are shown hereinafter:

TABLE III

| Suds | | | | Comparative | Comparative | Comparative | Comparative |
|---|---|---|---|---|---|---|---|
| Profile | Inventive | Inventive | Inventive | Example 1 | Example 2 | Example 3 | Example 4 |
| (cm) | Example 1 | Example 2 | Example 3 | (palm kernel oil) | (tallow oil) | (lower C14) | (higher C14) |
| Wash Suds | 28.2 | 28.5 | 26.7 | 32.4 | 38.1 | 20.7 | 33.1 |
| Height | | | | | | | |
| Rinse Suds | 6.1 | 6.2 | 6.2 | 13.0 | 16.2 | 11.6 | 17.0 |
| Height | | | | | | | |

An improved suds profile is characterized herein by: (1) a Wash Suds Height of more than 20 cm, preferably greater than 25 cm, and more preferably greater than 28 cm; and (2) a Rinse Suds Height of less than 10 cm, preferably less than 8 cm, and more preferably less than 7 cm. It is clear from the above table that only the inventive examples 1-3 exhibit the improved suds profile, while the comparative examples 1-4 fail to exhibit such improved suds profile.

### Exemplary Liquid Laundry Detergent Compositions

The following liquid laundry detergent compositions are prepared by traditional means known to those of ordinary skill in the art by mixing the following ingredients.

TABLE IV

| Ingredients (wt %) | A | B | C |
|---|---|---|---|
| AES¹ | 17.00 | 2.00 | 11.00 |
| LAS² | 2.80 | 15.00 | 10.00 |
| AE³ | 2.30 | 2.37 | 3.44 |
| Citric Acid | 5.00 | 1.98 | — |
| Boric Acid | — | 1.00 | 3.00 |
| Amine Oxide | 1.20 | — | 0.50 |
| Trimethyl Lauryl Ammonium | — | 1.50 | — |
| Chloride | | | |
| C₁₂-C₁₈ Fatty Acids | 1.20⁴ | 1.20⁵ | 1.20⁶ |
| Protease (54.5 mg/g)⁷ | 7.62 | 7.98 | 2.08 |
| Amylase (29.26 mg/g)⁸ | 2.54 | 2.67 | 0.69 |
| Xyloglucanase⁹ | — | — | 0.15 |
| Borax | 4.72 | 4.94 | — |
| Calcium Formate | 0.15 | 0.16 | 0.16 |
| Ethoxylated Polyethylenimine¹⁰ | 1.65 | 1.73 | 1.74 |
| Amphiphilic polymer¹¹ | — | 1.50 | 4.36 |
| Hexamethylene diamine, | — | — | 1.68 |
| ethoxylated, quaternized, | | | |
| sulfated¹² | | | |
| DTPA¹³ (50% active) | 0.28 | 0.30 | 0.64 |
| Tiron ® | 0.84 | 0.89 | — |
| Optical Brightener¹⁴ | 0.34 | 0.37 | 0.36 |
| Ethanol | 0.97 | 4.10 | 2.99 |
| Propylene Glycol | 4.90 | 5.16 | 8.49 |
| Diethylene Glycol | — | — | 4.11 |
| Monoethanolamine (MEA) | 1.12 | 1.17 | 0.23 |
| Caustic Soda (NaOH) | 3.50 | 3.74 | 2.10 |
| Na Formate | 0.61 | 0.64 | 0.23 |
| Na Cumene Sulfonate | — | — | 1.00 |
| Suds Suppressor | — | — | 0.18 |
| Dye | 0.01 | — | 0.02 |
| Perfume | 0.85 | — | 1.00 |
| Preservative¹⁵ | 0.05 | 0.50 | — |
| Hydrogenated castor oil | — | — | 0.27 |
| Water | Q.S. | Q.S. | Q.S. |

¹AES can be AE_{1.5}S, AE₂S, and/or AE₃S, in the amount ranging from 0-20%.
²LAS can be provided in the amount ranging from 0-20%.
³AE is a C12-14 alcohol ethoxylate, with an average degree of ethoxylation of 7-9, supplied by Huntsman, Salt Lake City, Utah, USA. It can be provided in the amount ranging from 0-10%.
⁴Having the same Fatty Acids Distribution Profile as Example 1 hereinabove.
⁵Having the same Fatty Acids Distribution Profile as Example 2 hereinabove.
⁶Having the same Fatty Acids Distribution Profile as Example 3 hereinabove.
⁷Proteases may be supplied by Genencor International, Palo Alto, California, USA (e.g., Purafect Prime ®, Excellase ®) or by Novozymes, Bagsvaerd, Denmark (e.g. Liquanase ®, Coronase ®).
⁸Available from Novozymes, Bagsvaerd, Denmark (e.g., Natalase ®, Mannaway ®).
⁹Available from Novozymes (e.g., Whitezyme ®).
¹⁰Polyethyleneimine (MW = 600) with 20 ethoxylate groups per —NH.
¹¹Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units, available from BASF as Sokalan PG101 ®.
¹²A compound having the following general structure: bis((C₂H₅O)(C₂H₄O)ₙ)(CH₃)—N⁺—CₓH₂ₓ—N⁺—(CH₃)-bis((C₂H₅O)(C₂H₄O)ₙ), wherein n = from 20 to 30, and x = from 3 to 8, or sulphated or sulphonated variants thereof, available from BASF as Lutenzit Z 96 ®
¹³DTPA is diethylenetriaminepentaacetic acid supplied by Dow Chemical, Midland, Michigan, USA.
¹⁴Suitable Fluorescent Whitening Agents are for example, Tinopal ® AMS, Tinopal ® CBS-X, Sulphonated zinc phthalocyanine Ciba Specialty Chemicals, Basel, Switzerland. It can be provided in the amount ranging from 0-5%.
¹⁵Suitable preservatives include methylisothiazolinone (MIT) or benzisothiazolinone (BIT), which can be provided in the amount ranging from 0-1%.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
(a) from 1 wt % to 20 wt % of a C₁₀-C₂₀ linear or branched alkylethoxy sulfate (AES) having an average degree of ethoxylation ranging from 1 to 3; and
(b) from 0.1 wt % to 4 wt % of two or more fatty acids or salts thereof, wherein said two or more fatty acids or salts have a Fatty Acids Distribution Profile that is characterized by from 30% to 90% of C₁₄ saturated fatty acids or salts thereof by total weight of said two or more fatty acids or salts.

2. The liquid laundry detergent composition of claim 1, wherein said Fatty Acids Distribution Profile is further characterized by:
(i) from 5% to 50% of C₁₂ saturated fatty acids or salts thereof;
(ii) from 35% to 80% of C₁₄ saturated fatty acids or salts thereof;
(iii) from 0% to 35% of C₁₆ saturated fatty acids or salts thereof; and
(iv) from 0% to 10% of C₁₈ saturated fatty acids or salts thereof,
by total weight of said two or more fatty acids or salts.

3. The liquid laundry detergent composition of claim 1, wherein said Fatty Acids Distribution Profile is further characterized by at least 80 wt %, preferably at least 90 wt %, and more preferably 100 wt %, of saturated fatty acids or salts thereof.

4. The liquid laundry detergent composition of claim 1, which is characterized by an AES-to-fatty-acids weight ratio ranging from 40:1 to 1:2, respectively, preferably from 20:1 to 1:1, and more preferably from 15:1 to 2:1.

5. The liquid laundry detergent composition of claim 1, having a pH value ranging from 6 to 9, and preferably from 7 to 8.

6. The liquid laundry detergent composition of claim 1, having a suds profile that is characterized by: (1) a Wash Suds Height of greater than 20 cm, preferably greater than 25 cm, and more preferably greater than 28 cm; and (2) a Rinse Suds Height of less than 10 cm, preferably less than 8 cm, and more preferably less than 7 cm.

7. The liquid laundry detergent composition of claim 1, further comprising one or more additional anionic surfactants and/or nonionic surfactants, wherein said composition is characterized by a total surfactant-to-fatty-acids weight ratio ranging from 40:1 to 1:2, respectively, preferably from 20:1 to 1:1, and more preferably from 15:1 to 2:1.

8. The liquid laundry detergent composition of claim 1, having a total surfactant content of no more than 25 wt %, preferably no more than 15 wt %, and more preferably no more than 10 wt %.

9. The liquid laundry detergent composition of claim 1, further comprising from 0 wt % to 25 wt % of one or more non-ionic surfactants.

10. The liquid laundry detergent composition of claim 1, further comprising from 1 wt % to 25 wt % of one or more solvents selected from the group consisting of glycerin, pentanediol, 1,2-propanediol, ethanol, diethylene glycol, sodium cumene sulfonate, and momoethanolamine.

11. The liquid laundry detergent composition of claim 1, further comprising from 0 wt % to 9 wt % of an acid selected from citric acid and boric acid.

12. A concentrated liquid laundry detergent composition comprising:
(a) from 20 wt % to 50 wt % of a C₁₀-C₂₀ linear or branched alkylethoxy sulfate (AES) having an average degree of ethoxylation ranging from 1 to 3; and
(b) from 4 wt % to 10 wt % of two or more fatty acids or salts thereof, wherein said two or more fatty acids or salts thereof have a Fatty Acids Distribution Profile that is characterized by from 30% to 90% of C₁₄ saturated fatty acids or salts thereof by total weight of said two or more fatty acids or salts.

13. The concentrated liquid laundry detergent composition of claim 12, further comprising from 0 wt % to 50 wt %, preferably from 25 wt % to 45%, and more preferably from 30 wt % to 40 wt % of one or more non-ionic surfactants.
